(19) United States
(12) Patent Application Publication
(10) Pub. No.: US 2018/0030562 A1
(43) Pub. Date: Feb. 1, 2018

(54) HEAT TREATMENT OF STEEL PARTS, PARTICULARLY FRICTION-WELDED STEEL PARTS

(71) Applicant: THE GLEASON WORKS, Rochester, NY (US)

(72) Inventor: Arthur C. Reardon, Webster, NY (US)

(21) Appl. No.: 15/221,993

(22) Filed: Jul. 28, 2016

(51) Int. Cl. C21D 9/32; C21D 6/00; B23K 20/12; C21D 9/50

(52) U.S. Cl. CPC C21D 9/32; C21D 9/505; C21D 6/00; B23K 20/12

(57) ABSTRACT

A heat treatment process for a non-quench hardened steel article or friction-welded steel article including normalizing and annealing steps whereby uniformity of microstructure and hardness are significantly improved.

### FIELD OF THE INVENTION

The invention is directed to heat treating of steel parts and in particular to heat treating of friction welded steel parts, such as gears and the like.

### BACKGROUND OF THE INVENTION

Friction welding, also known as inertia welding, is a process of joining together two metals, such as steel, which may or may not have similar compositions. Friction welding forges metals together using pressure and rotational forces with no melting of the metals since the joining temperature is relatively low. The process, per se, is known to the skilled artisan and no further explanation of the basic process is believed necessary for an understanding of the invention.

Friction welding may be utilized in the production and assembly of some gears, such as those where the attachment of a hub or support bearing (sometimes referred to as a third pinion bearing) to the front face of a gear (e.g. a bevel pinion) is desired. In another example, friction welding may also be utilized to attach a shaft to the back face of a bevel pinion.

While friction welding produces no melting of the metals, a weld zone is formed. With gears, it has been noted that the hardness of the weld zone is greater than that of the surrounding metals. Furthermore, after welding, there is a discernable lack of uniformity in the microstructure of the metals and the microstructure of the weld zone.

### SUMMARY OF THE INVENTION

The invention comprises a heat treatment process for a friction-welded steel article including normalizing and annealing steps whereby uniformity of microstructure and hardness are significantly improved.

### BRIEF DESCRIPTION OF THE DRAWINGS

FIG. 1 illustrates a pinion member having a hub friction welded thereto.

FIG. 2 is a micrograph of a weld zone of a friction welded pinion and hub.

FIG. 3 is a micrograph of pinion microstructure prior to the inventive heat treatment.

FIG. 4 is a micrograph of pinion microstructure after the normalizing step of the invention.

FIG. 5 is a micrograph of pinion microstructure after the normalizing and annealing steps according to the invention.

FIG. 6 is a micrograph of a weld zone of a friction welded pinion and hub after normalizing and annealing according to the invention

### DETAILED DESCRIPTION OF THE PREFERRED EMBODIMENT

The terms “invention,” “the invention,” and “the present invention” used in this specification are intended to refer broadly to all of the subject matter of this specification and any patent claims below. Statements containing these terms should not be understood to limit the subject matter described herein or to limit the meaning or scope of any patent claims below. Furthermore, this specification does not seek to describe or limit the subject matter covered by any claims in any particular part, paragraph, statement or drawing of the application. The subject matter should be understood by reference to the entire specification, all drawings and any claim below. The invention is capable of other constructions and of being practiced or being carried out in various ways. Also, it is understood that the phraseology and terminology used herein is for the purposes of description and should not be regarded as limiting.

The details of the invention will now be discussed with reference to the accompanying drawings which illustrate the invention by way of example only. In the drawings, similar features or components will be referred to by like reference numbers.

The use of “including”, “having” and “comprising” and variations thereof herein is meant to encompass the items listed thereafter and equivalents thereof as well as additional items.

Although references may be made below to directions such as upper, lower, upward, downward, rearward, bottom, top, front, rear, etc., in describing the drawings, these references are made relative to the drawings (as normally viewed) for convenience. These directions are not intended to be taken literally or limit the present invention in any form.

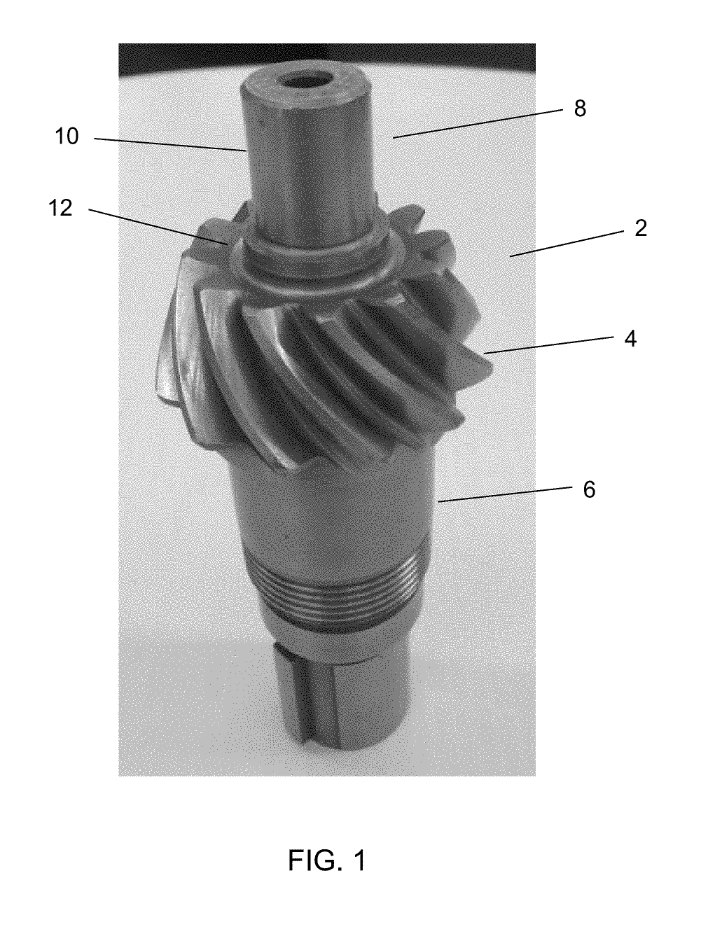

FIG. 1 shows a pinion member 2 (i.e. the pinion) of a bevel gear set. The other member of the bevel gear set which meshes with the pinion member 2 is a bevel ring gear member (i.e. the ring gear, not shown). Pinion 2 comprises teeth 4 and includes a shaft portion 6. Pinion 2 further includes a hub portion 8 having a journal 10 on which a bearing (not shown) may be placed. Hub portion 8 is attached to the front face 12 of pinion 2 via friction welding.

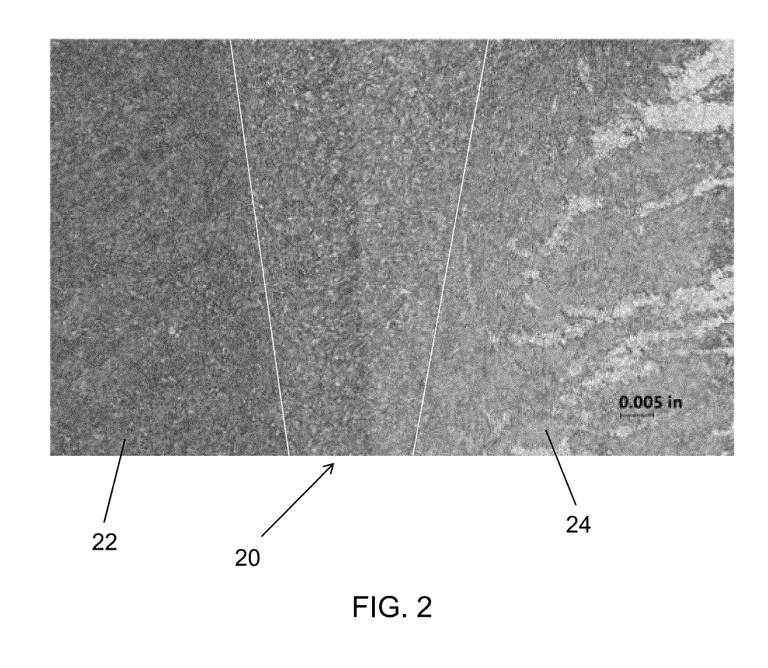

FIG. 2 is a micrograph (50× magnification) of a weld zone 20 (white lines added for delimitation purposes) between a friction welded pinion face and a hub portion such as the pinion face 12 and hub 8 of FIG. 1. Both the pinion and hub are comprised of as-received and non-quench hardened AISI 9310 steel having the composition (wt. %):

Carbon 0.07-0.13

Nickel 2.95-3.55

Chromium 1.00-1.45

Manganese 0.40-0.70

Silicon 0.15-0.35

Molybdenum 0.08-0.15

Phosphorus 0.025 maximum

Sulfur 0.025 maximum

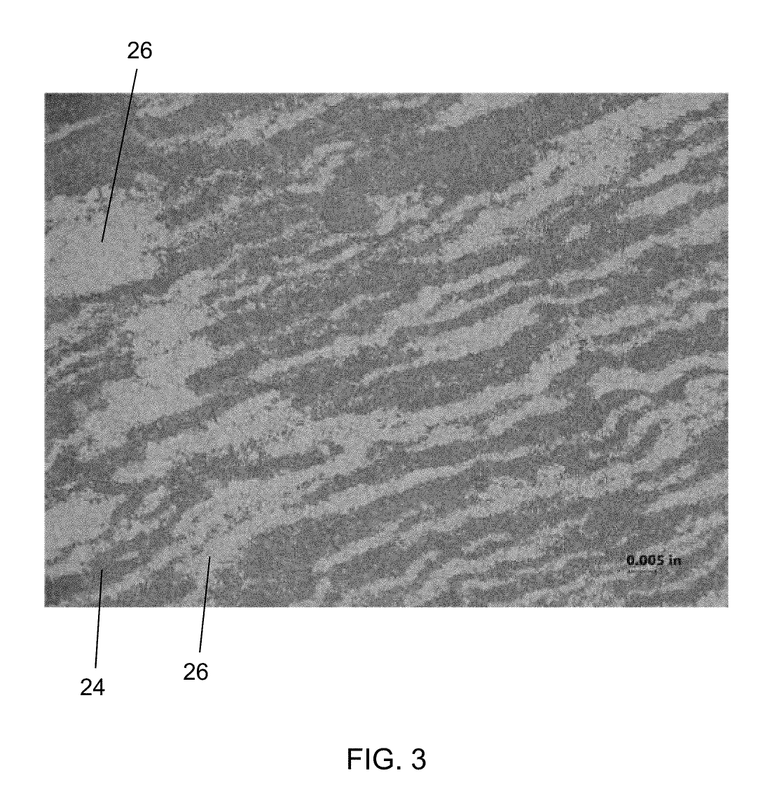

The microstructure 22 of the hub 8 is shown to the left of weld zone 20 while the microstructure 24 of the pinion 2 is shown to the right of weld zone 20. Note the significant number and sizes of ferrite islands 26 (see also FIG. 3) in the pinion microstructure 24. In this example, the hardness of weld zone 20 was 42 Rockwell C and the hardness of the hub microstructure 22 and the pinion microstructure 24 was 20.5 Rockwell C.

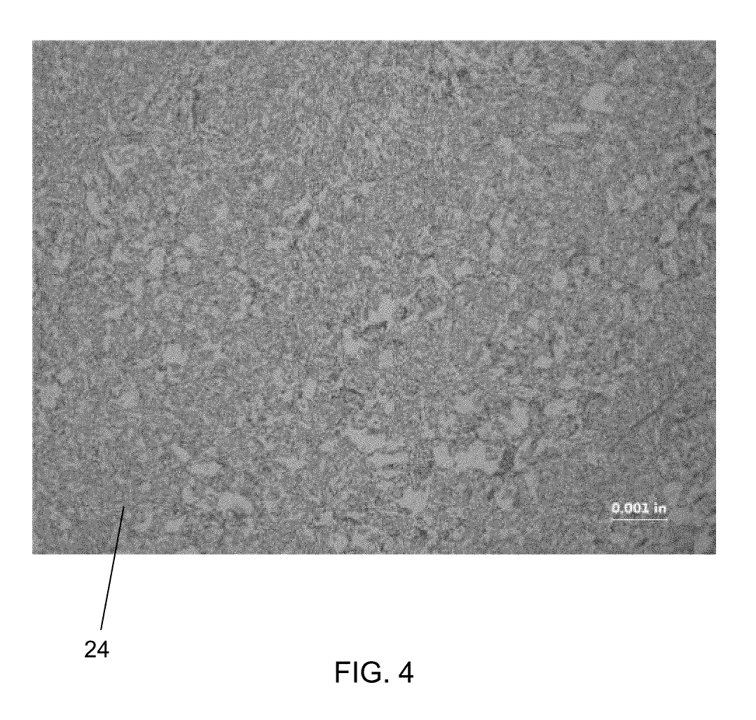

In a first step, a gear such as pinion 2 is normalized at a first hold temperature in the range of about 1650° F. to about 1750° F. for a period of at least six hours followed by cooling (i.e. the first cooling step) to room temperature preferably in still air although the air may be agitated, preferably slightly agitated, such as, for example, by a fan. FIG. 4 is a micrograph (500× magnification) of the same gear as FIG. 2 (9310 steel) wherein the gear has been normalized at 1750° F. for six hours and then cooled in still air. The hardness of the microstructure 24 was 99.5 Rockwell B (about 22 Rockwell C) and the hardness of the weld zone was 27 Rockwell C.

Following normalizing and cooling, the gear is isothermally annealed at a subcritical second hold temperature in the range of about 1200° F. to about 1250° F. for a period of at least 4 hours. The gear is then cooled to room temperature (i.e. the second cooling step). The second cooling step may comprise furnace cooling to about 600° F. followed by cooling in air to room temperature. Alternatively, the second cooling step may comprise cooling in air to room temperature.

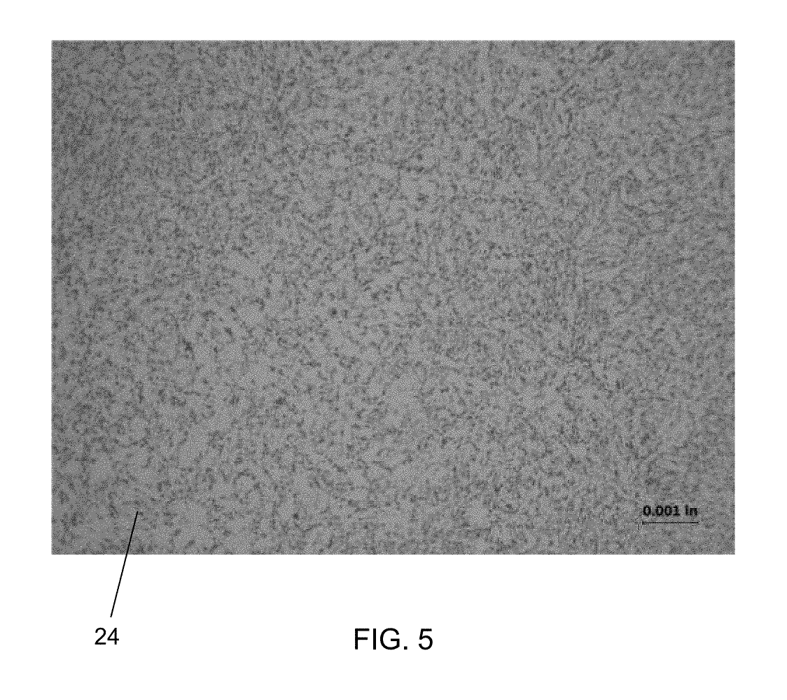

FIG. 5 is a micrograph (500× magnification) of the gear of FIG. 4 (9310 steel) wherein the gear has been annealed at 1250° F. for four hours and then cooled in still air. The hardness of the microstructure 24 was 90 Rockwell B and the hardness of the weld zone was 92 Rockwell B.

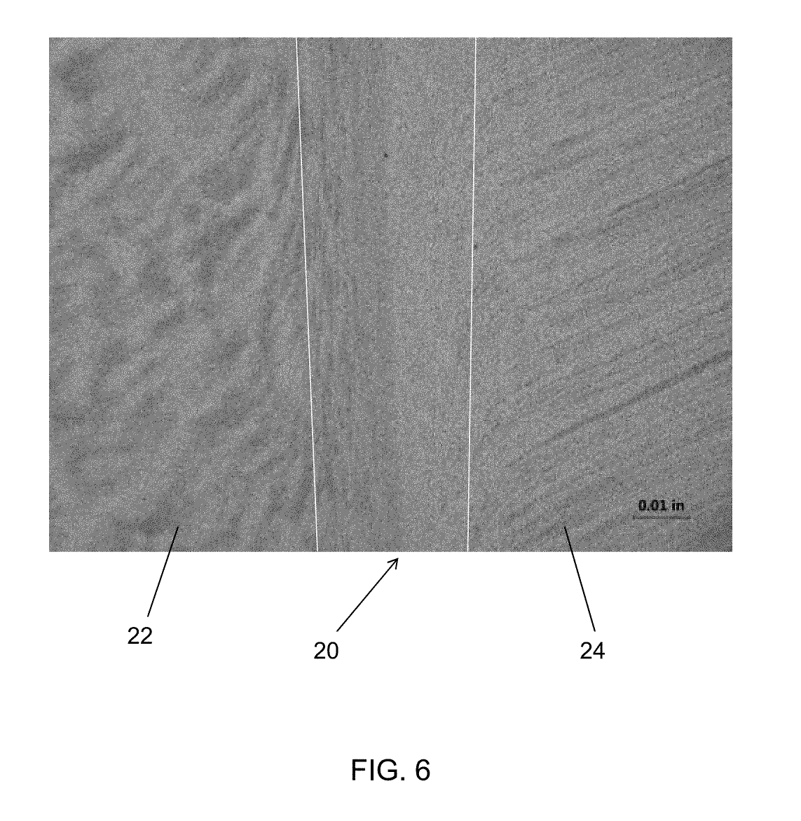

FIG. 6 is a micrograph (50× magnification) of the friction weld zone 20 (white lines added for delimitation purposes) after the inventive normalizing and annealing process. As can be seen, the microstructure is much more uniform compared to FIG. 2. The hardness, noted above, is nearly uniform compared to the pre-treatment values of 20.5 Rockwell C and 42 Rockwell C.

The temperature range of 1650° F.-1750° F. for normalizing the steel articles was selected for several reasons. If the steel articles are subsequently case carburized after normalizing, the carburizing temperature should be less than the normalizing temperature that was used. Distortion in the parts during carburizing and subsequent hardening and tempering operations is the main reason for specifying that the carburizing temperature should be less than the normalizing temperature. Carburizing furnaces typically have a tolerance of +/−25° F. or less regarding the aim temperature that is selected. To ensure that the carburizing temperature does not exceed the stated normalizing temperature, this temperature variation within the working zone of the furnace should be taken into consideration. This is why typical guidance mandates that the carburizing temperature needs to be at least 25° F. below the normalizing temperature. Therefore, for a normalizing temperature of 1650° F., the carburizing temperature would be at most 1625° F. if this guidance is followed. Since gas carburizing is a diffusion controlled process, the lower the temperature the longer it takes to reach a given case depth profile. And at temperatures below 1625° F., it simply takes too long (and it becomes more expensive) to carburize most articles (i.e. parts). At temperatures above 1750° F. grain growth commences more rapidly which is unwanted. For hold times less than six hours, incomplete or partial normalizing is likely to occur.

The subcritical isothermal annealing temperature range of 1200° F.-1250° F. was selected so that adequate softening would take place within a reasonable length of time without exceeding the lower critical temperature of the steel. Exceeding the lower critical temperature of the steel would induce an unwanted austenitic transformation to occur. Hence, the annealing could no longer be identified as a subcritical anneal. For hold times less than four hours, inadequate softening is likely to occur.

While the invention has been discussed and illustrated with AISI 9310 steel, other through-hardening or surface-hardening steels (non-quench hardened) of similar compositions may be utilized such as, for example, AISI 3310 steel which comprises (wt. %):

Carbon 0.08-0.13

Nickel 3.25-3.75

Chromium 1.40-1.75

Manganese 0.40-0.60

Silicon 0.15-0.35

Phosphorus 0.025 maximum

Sulfur 0.025 maximum

Although the invention has been discussed with respect to gears, other friction welded steel articles are contemplated. The inventive process yields a uniform microstructure that may be readily carburized and heat treated (subsequent manufacturing steps in the production of some gears) with minimal distortion. It should also be noted that non-quench hardened and non-friction-welded steel articles may also benefit from the inventive method due to the resulting uniform microstructure that may be readily carburized and heat treated.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A method of heat treating a non-quench hardened steel article, said method comprising:
heating said article to a first hold temperature in the range of about 1650° F. to about 1750° F.;
cooling said article to room temperature in a first cooling step;
heating said article to a second hold temperature in the range of about 1200° F. to about 1250° F.;
cooling said article to room temperature in a second cooling step.

2. The method of claim 1 wherein said article is held at said first hold temperature for a period of at least six hours.

3. The method of claim 1 wherein said first cooling step takes place in air.

4. The method of claim 1 wherein said first cooling step takes place in slightly agitated air.

5. The method of claim 1 wherein said article is held at said second hold temperature for a period of at least four hours.

6. The method of claim 1 wherein said second cooling step comprises furnace cooling to about 600° F. followed by cooling in air to room temperature.

7. The method of claim 1 wherein said second cooling step comprises cooling in air to room temperature.

8. The method of claim 1 wherein said steel article comprises AISI 9310 steel.

9. The method of claim 1 wherein said steel article comprises AISI 3310 steel.

10. The method of claim 1 wherein said steel article comprises a gear.

11. The method of claim 10 wherein said gear further includes a hub friction welded thereto.

12. The method of claim 1 wherein said steel article comprises a friction-welded steel article.
